(19) United States
(12) Patent Application Publication
(10) Pub. No.: US 2005/0089102 A1
(43) Pub. Date: Apr. 28, 2005

(54) Video processing

(76) Inventors: Roberto Alvarez Arevalo, Ipswich (GB); Matthew D Walker, Ipswich (GB)

Correspondence Address: NIXON & VANDERHYE, PC, 1100 N GLEBE ROAD, 8TH FLOOR, ARLINGTON, VA, 22201-4714, US

(21) Appl. No.: 10/503,056

(22) PCT Filed: Feb. 19, 2003
(86) PCT No.: PCT/GB03/00704

(30) Foreign Application Priority Data
Feb. 21, 2002 (EP) 02251185.1

(51) Int. Cl. H04N 7/12

(52) U.S. Cl. 375/240.27

(57) ABSTRACT

A method of video processing comprising: receiving (110) video data; dividing the received video data in segments and encoding the video data of a segment. A field is inserted to indicate the size of the encoded video segment. The video data is decoded by identifying the start of an encoded video segment and decoding the associated data. When an attempt to identify the start of an encoded video segment is unsuccessful, a field indicating the size of the encoded video segment is examined and a search carried out for the start of an encoded video segment in the portion of the bit stream indicated by the examined field. When the start of a video segment is identified, the remaining video data of the encoded video segment is then decoded.

This invention relates to video decoding and in particular to methods and apparatus for detecting, isolating and repairing errors within a video bitstream.

A video sequence consists of a series of still pictures or frames. Video compression methods are based on reducing the redundant and the perceptually irrelevant parts of video sequences. The redundancy in video sequences can be categorised into spectral, spatial and temporal redundancy. Spectral redundancy refers to the similarity between the different colour components of the same picture. Spatial redundancy results from the similarity between neighbouring pixels in a picture. Temporal redundancy exists because objects appearing in a previous image are also likely to appear in the current image. Compression can be achieved by taking advantage of this temporal redundancy and predicting the current picture from another picture, termed anchor or reference picture. Further compression may be achieved by generating motion compensation data that describes the displacement between areas of the current picture and similar areas of the reference picture.

Frames coded without reference to another frame are known as intra-frames (also known as I-frames). Pictures that are compressed using temporal redundancy techniques are generally referred to as inter-pictures or inter-frames (also known as P-frames). Parts of an inter-picture can also be encoded without reference to another frame (known as intra-refresh).

Sufficient compression cannot usually be achieved by only reducing the inherent redundancy of a sequence. The redundancy of the encoded bit stream is usually therefore further reduced by means of efficient lossless coding of compression parameters. The main technique is to use variable length codes.

Compressed video is usually corrupted by transmission errors, mainly for two reasons. Firstly, due to utilisation of temporal predictive differential coding (inter-frame coding) an error is propagated both spatially and temporally. In practise this means that, once an error occurs, it is usually visible to the human eye for a relatively long time. Especially susceptible are transmissions at low bit rates where there are only a few intra-coded frames, so temporal error propagation is not stopped for some time. Secondly, the use of variable length codes increases susceptibility to errors. When a bit error alters the code word, the decoder will lose code word synchronisation and also decode subsequent error-free code words (comprising several bits) incorrectly until the next synchronisation (or start) code. A synchronisation code is a bit pattern which cannot be generated from any legal combination of other code words and such start codes are added to the bit stream at intervals to enable resynchronisation. In addition, errors occur when data is lost during transmission. For example, for video applications using an unreliable transport protocol such as UDP in IP Networks, network elements may discard parts of the encoded bit stream.

The transmission of video data over networks prone to transmission errors (for instance mobile networks) is subject to channel errors and channel congestion. Even a low Bit Error Rate (BER) can produce a significant degradation of video quality. Whilst channel error may cause significant visual impairments, it is undesirable to request a transmitting device to retransmit the corrupted data as any re-transmitted information is likely to be subject to similar channel degradation and also processing and transmitting resources may be unnecessarily occupied when other data is to be transmitted. Thus techniques have been developed to detect, isolate and/or conceal errors at a decoder.

There are many ways for the receiver to address the corruption introduced in the transmission path. In general, on receipt of the signal, transmission errors are first detected and then corrected or concealed by the receiver. Error correction refers to the process of recovering the erroneous data preferably as if no errors had been introduced in the first place. Error concealment refers to the process of concealing the effects of transmission errors so that they are hardly visible in the reconstructed video sequence. Typically an amount of redundancy is added by the source transport coding in order to help error detection, correction and concealment.

Current video coding standards define a syntax for a self-sufficient video bit-stream. The most popular standards at the time of writing are ITU-T Recommendation H.263, “Video coding for low bit rate communication”, February 1998; ISO/IEC 14496-2, “Generic Coding of Audio-Visual Objects. Part 2: Visual”, 1999 (known as MPEG-4); and ITU-T Recommendation H.262 (ISO/IEC 13818-2) (known as MPEG-2). These standards define a hierarchy for bit-streams and correspondingly for image sequences and images.

According to a first aspect of the present invention, there is provided a method of decoding encoded video data, comprising:
identifying a start of an encoded segment of video data;
identifying a field located in a known relation to the start of the segment;
searching in the encoded data at the location indicated by the field so as to locate a start of a previous segment.

In accordance with the embodiments there is provided a method of video processing comprising:
receiving video data;
dividing the received video data in segments;
encoding the video data of a segment;
inserting a field indicating the size of the encoded video segment; transmitting the encoded video data; receiving encoded video data;
attempting to decode the video data by identifying the start of an encoded video segment;
when an attempt to identify the start of an encoded video segment is unsuccessful, examining a field indicating the size of the encoded video segment and searching for the start of an encoded video segment in the portion of the bit stream indicated by the examined field and,
when the start of a video segment is identified, decoding the remaining video data of the encoded video segment.

In a second aspect of the embodiments there is provided a method of video decoding comprising:
receiving encoded video data;
attempting to decode the video data by identifying the start of an encoded video segment;
when an attempt to identify the start of an encoded video segment is unsuccessful, examining a field indicating the size of the encoded video segment and searching for the start of an encoded video segment in the portion of the bit stream indicated by the examined field and,
when the start of a video segment is identified, decoding the remaining video data of the encoded video segment.

Thus, rather than discarding the segment for which a start code cannot be found, the length field provides an indication to a decoder as to the location of the start of the segment. A decoder can then look for a start code or the like within that region of the bit-stream indicated by the length field and make an attempt to correct an error in the bit-stream and so recover the segment data.

The method may further comprise attempting to resolve an error in a code word indicating the start of a video segment.

When the start of a video segment is identified, preferably a step of validating the identification is carried out by means of searching for a pre-defined field associated with the start of the segment. For instance, the pre-defined field may indicate the number of the segment within the video data.

According to a second aspect of the present invention, there is provided a method of encoding video data, comprising:
encoding video data into a plurality of segments, including inserting a field into the data at a predetermined relation to the start of a segment, said field indicating the location in the encoded data of the start of a previous segment.

According to a further aspect of the embodiments there is provided a method of video encoding comprising:
receiving video data;
dividing the received video data in segments;
encoding the video data of a segment;
inserting a field indicating the size of the encoded video segment.

Preferably the segment is a Group of Blocks or a Slice. The field may be located in a picture segment layer of the encoded video or the picture layer of the encoded video data, for instance.

In a further aspect of the embodiments there is provided a system of video processing comprising:
an input for receiving video data;
a processor for dividing the received video data in segments;
an encoder for encoding the video data of a segment, the encoder being arranged to insert a field indicating the size of the encoded video segment;
an output from which the video data is transmitted the encoded video data;
an input for receiving encoded video data;
a decoder to decode the received encoded video data, the decoder being arranged to:
attempt to decode the video data by identifying the start of an encoded video segment;
when an attempt to identify the start of an encoded video segment is unsuccessful, to examine a field indicating the size of the encoded video segment;
to search for the start of an encoded video segment in the portion of the bit stream indicated by the examined field; and,
when the start of a video segment is identified, to decode the remaining video data of the encoded video segment.

In a further aspect of the embodiments there is provided a video decoder to decode received encoded video data, the decoder being arranged to:
attempt to decode the video data by identifying the start of an encoded video segment;
when an attempt to identify the start of an encoded video segment is unsuccessful, to examine a field indicating the size of the encoded video segment;
to search for the start of an encoded video segment in the portion of the bit stream indicated by the examined field; and,
when the start of a video segment is identified, to decode the remaining video data of the encoded video segment.

In a further aspect of the embodiments there is provided a video encoder comprising:
an input for receiving video data divided into segments;
an encoder processor for encoding the video data of a segment, the encoder being arranged to insert a field indicating the size of the encoded video segment; and
an output from which the video data is transmitted the encoded video data.

The invention will now be described, by way of example only, with reference to the accompanying drawings, in which:

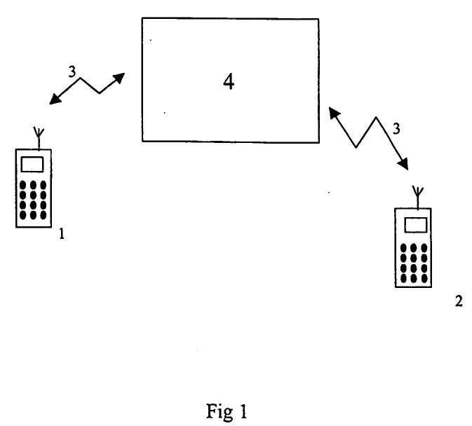

FIG. 1 shows a multimedia mobile communications system;

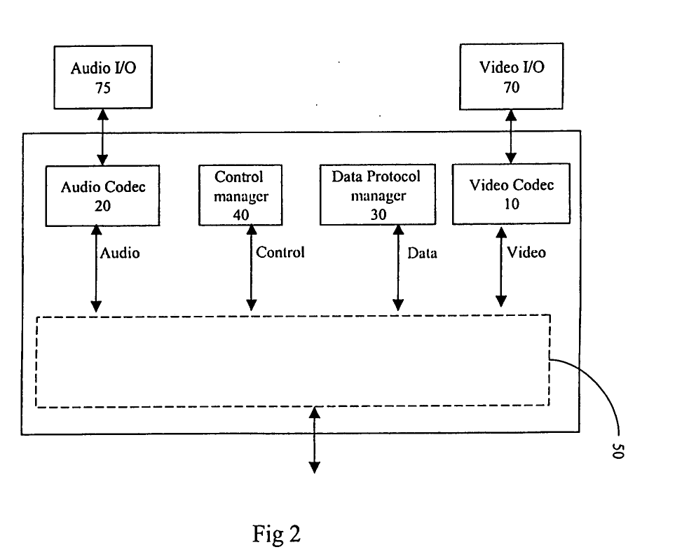

FIG. 2 shows an example of the multimedia components of a multimedia terminal;

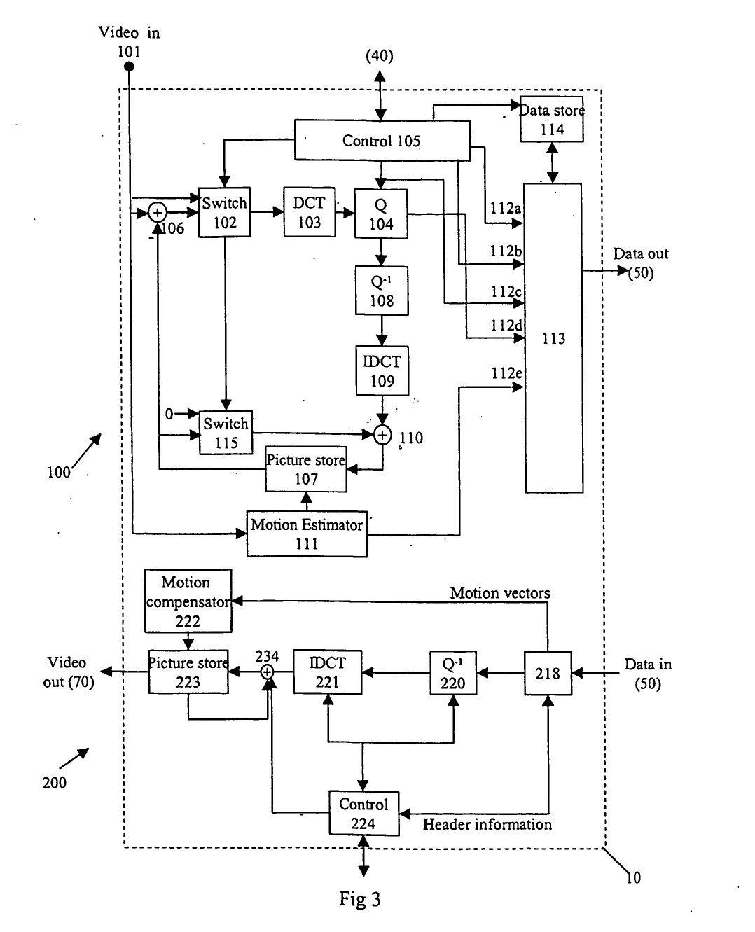

FIG. 3 shows an example of a video codec;

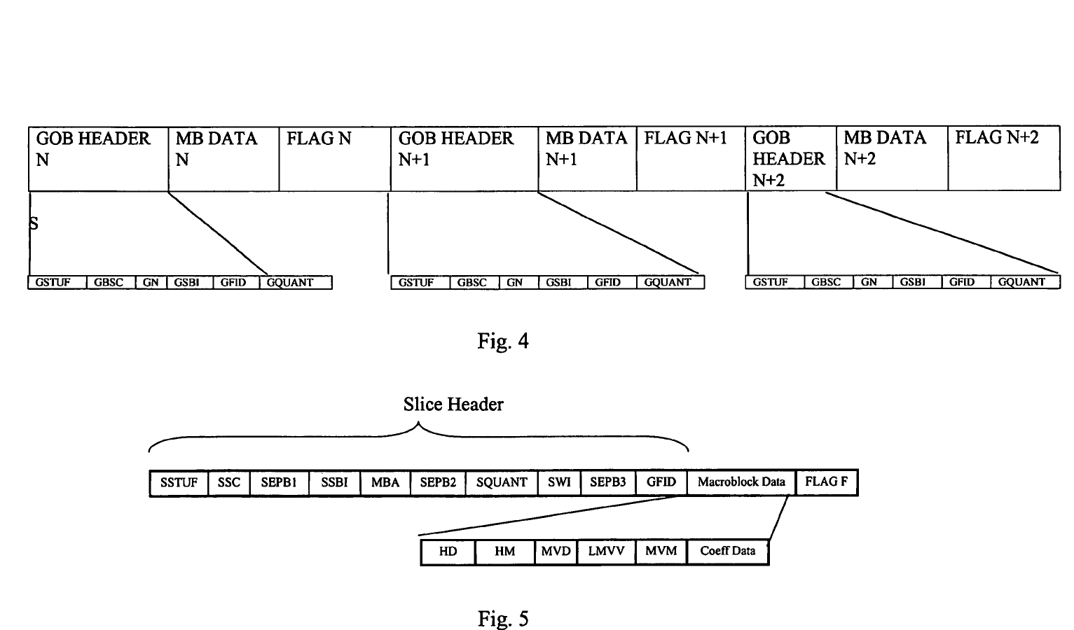

FIG. 4 shows an example of the structure of a bit stream produced according to a first embodiment of the invention; and

FIG. 5 shows an example of the structure of a bit stream produced according to a second embodiment of the invention.

FIG. 1 shows a typical multimedia mobile communications system. A first multimedia mobile terminal 1 communicates with a second multimedia mobile terminal 2 via a radio link 3 to a mobile communications network 4. Control data is sent between the two terminals 1,2 as well as the multimedia data.

FIG. 2 shows the typical multimedia components of a terminal 1. The terminal comprises a video codec 10, an audio codec 20, a data protocol manager 30, a control manager 40, a multiplexer/demultiplexer 50 and a modem 60 (if the required). For packet-based transport networks (e.g. IP based-networks) the multiplexer/demultiplexer 50 and modem 60 are not required.

The video codec 10 receives signals for coding from a video capture or storage device of the terminal (not shown) (e.g. a camera) and receives signals for decoding from a remote terminal 2 for display by the terminal 1 on a display 70. The audio codec 20 receives signals for coding from the microphone (not shown) of the terminal 1 and receive signals for decoding from a remote terminal 2 for reproduction by a speaker (not shown) of the terminal 1. The terminal may be a portable radio communications device, such as a radio telephone.

The control manager 40 controls the operation of the video codec 10, the audio codec 20 and the data protocols manager 30. However, since the invention is concerned with the operation of the video codec 10, no further discussion of the audio codec 20 and protocol manager 30 will be provided.

FIG. 3 shows an example of a video codec 10 according to the invention. Since H.263 is a widely adopted standard for video in low bit-rate environments, the codec will be described with reference to H.263. However, it is not intended that the invention be limited to this standard.

The video codec comprises an encoder part 100 and a decoder part 200. The encoder part 100 comprises an input 101 for receiving a video signal from a camera or video source of the terminal 1. A switch 102 switches the encoder between an INTRA-mode of coding and an INTER-mode. The encoder part 100 of the video codec 10 comprises a DCT transformer 103, a quantiser 104, an inverse quantiser 108, an inverse DCT transformer 109, an adder 110, one or more picture stores 107, a subtractor 106 for forming a prediction error, a switch 113 and an encoding control manager 105.

The operation of an encoder according to the invention will now be described. The video codec 10 receives a video signal to be encoded. The encoder 100 of the video codec encodes the video signal by performing DCT transformation, quantisation and motion compensation. The encoded video data is then output to the multiplexer 50. The multiplexer 50 multiplexes the video data from the video codec 10 and control data from the control 40 (as well as other signals as appropriate) into a multimedia signal. The terminal 1 outputs this multimedia signal to the receiving terminal 2 via the modem 60 (if required).

In INTRA-mode, the video signal from the input 101 is transformed to DCT co-efficients by a DCT transformer 103. The DCT coefficients are then passed to the quantiser 104 that quantises the coefficients. Both the switch 102 and the quantiser 104 are controlled by the encoding control manager 105 of the video codec, which may also receive feedback control from the receiving terminal 2 by means of the control manager 40. A decoded picture is then formed by passing the data output by the quantiser through the inverse quantiser 108 and applying an inverse DCT transform 109 to the inverse-quantised data. The resulting data is added to the contents of the picture store 107 by the adder 110.

In INTER mode, the switch 102 is operated to accept from the subtractor 106 the difference between the signal from the input 101 and a reference picture which is stored in a picture store 107. The difference data output from the subtractor 106 represents the prediction error between the current picture and the reference picture stored in the picture store 107. A motion estimator 111 may generate motion compensation data from the data in the picture store 107 in a conventional manner.

The encoding control manager 105 decides whether to apply INTRA or INTER coding or whether to code the frame at all on the basis of either the output of the subtractor 106 or in response to feedback control data from a receiving decoder. The encoding control manager may decide not to code a received frame at all when the similarity between the current frame and the reference frame is so high or there is not time to code the frame. The encoding control manager operates the switch 102 accordingly.

When not responding to feedback control data, the encoder typically encodes a frame as an INTRA-frame either only at the start of coding (all other frames being inter-frames), or at regular periods e.g. every 5 s, or when the output of the subtractor exceeds a threshold i.e. when the current picture and that stored in the picture store 107 are judged to be too dissimilar. The encoder may also be programmed to encode frames in a particular regular sequence e.g. I P P P P I P etc.

The video codec outputs the quantised DCT coefficients 112a, the quantising index 112b (i.e. the details of the quantising used), an INTRA/INTER flag 112c to indicate the mode of coding performed (I or P), a transmit flag 112d to indicate the number of the frame being coded and the motion vectors 112e for the picture being coded. These are multiplexed together by the multiplexer 50 together with other multimedia signals.

The decoder part 200 of the video codec 10 comprises an inverse quantiser 220, an inverse DCT transformer 221, a motion compensator 222, one or more picture stores 223 and a controller 224. The controller 224 receives video codec control signals demultiplexed from the encoded multimedia stream by the demultiplexer 50. In practice the controller 105 of the encoder and the controller 224 of the decoder may be the same processor.

Considering the terminal 1 as receiving coded video data from terminal 2, the operation of the video codec 10 will now be described with reference to its decoding role. The terminal 1 receives a multimedia signal from the transmitting terminal 2. The demultiplexer 50 demultiplexes the multimedia signal and passes the video data to the video codec 10 and the control data to the control manager 40. The decoder 200 of the video codec decodes the encoded video data by inverse quantising, inverse DCT transforming and motion compensating the data. The controller 224 of the decoder checks the integrity of the received data and, if an error is detected, attempts to correct or conceal the error in a manner to be described below. The decoded, corrected and concealed video data is then stored in one of the picture stores 223 and output for reproduction on a display 70 of the receiving terminal 1.

In H.263, the bit stream hierarchy has four layers: block, macroblock, picture segment and picture layer. A block relates to 8×8 pixels of luminance or chrominance. Block layer data consist of uniformly quantised discrete cosine transform coefficients, which are scanned in zigzag order, processed with a run-length encoder and coded with variable length codes.

A macroblock relates to 16×16 pixels (or 2×2 blocks) of luminance and the spatially corresponding 8×8 pixels (or block) of chrominance components.

The picture segment layer can either be a group of blocks (GOB) layer or a slice layer. Each GOB or slice is divided into macroblocks. Data for each GOB consists of an optional GOB header followed by data for macroblocks. If the optional slice structured mode is used, each picture is divided into slices instead of GOBs. A slice contains a number of macroblocks but has a more flexible shape and use than GOBs. Slices may appear in the bit stream in any order. Data for each slice consists of a slice header followed by data for the macroblocks.

The picture layer data contain parameters affecting the whole picture area and the decoding of the picture data. Most of this data is arranged in a so-called picture header.

MPEG-2 and MPEG-4 layer hierarchies resemble the one in H.263.

Errors in video data may occur at any level and error checking may be carried out at any or each of these levels.

In a first embodiment of the invention, the picture segment layer is a group of blocks. As shown in FIG. 4, the data structure for each group of blocks consists of a GOB header followed by data for the macroblocks of the GOB N (MB data N). Each GOB contains one or more rows of macroblocks. The GOB header includes: GSTUF, a codeword of variable length to provide byte alignment; GBSC, a Group of Block start code, which is a fixed codeword of seventeen bits 0000 0000 0000 0000 1; GN, the number of the GOB being coded; GFID, the GOB frame identifier which has the same value for all GOBs of the same picture; and GQUANT, a fixed length codeword which indicates the quantiser to be used for the decoder.

Following the GOB header is the macroblock data which consists of a macroblock header followed by data for the blocks of the macroblock. At the end of the macroblock data for the GOB there is a flag field F. According to the invention, as each picture segment (i.e. GOB) is encoded, the control 105 of the encoder 100 inserts a flag F into the encoded data. This flag F indicates the length of the associated encoded picture segment. This length represents the total data used to encode the macroblock data for the segment i.e. the number of bits between one GBSC and the next.

The length flag may be provided in any suitable part of the bit stream e.g. the picture layer, picture segment layer or MB layer. However, to maintain a signal structure that is compliant with H.263 it is preferable that the flag is provided in the picture header, for instance as Supplemental Enhancement Information in the PSUPP field of the picture layer of H.263.

When a receiving decoder attempts to decode the received data, first the decoder looks for the GOB start code GBSC in a segment. Say the decoder has managed to successfully decode GOB number N. GOB_{N+1} is the next segment to be decoded. Clearly if the GBSC of GOB_{N+1} is found then the following GN should be N+1. However if an error has occurred, resulting in the decoder being unable to locate GBSC_{N+1}, then the next GOB start code that the decoder locates is GBSC_{N+2} followed by GN=N+2. If preventative steps were not taken, the decoder would then decode the data following the header with GN=N+2. It is clear that an error has occurred since GN=N+1 has not been decoded. At the end of the data relating to segment N+1 is the flag F_{N+1}. When a non-consecutive GN is decoded the decoder reads the preceding flag (in this case F_{N+1}) to determine the length of the previous encoded segment GOB_{N+1}. Once the decoder has read the flag F_{N+1}, the bit stream in the region indicated by flag F_{N+1} is then examined. For instance, say F_{N+1}=1003. The decoder back tracks from the current GBSC (GBSC_{N+2}) by 1003 bits and looks for a bit pattern that resembles the GBSC (0000 0000 0000 0000 1). If a bitstream resembling a GBSC is found (and is followed by the desired GN (GN=N+1 in this example)) then the error in the GBSC is corrected and the decoding of the segment GOB=N+1 is carried out. Alternatively, the decoder can simply skip the 17 bits of a GBSC from the position indicated by the flag F and then look for the rest of the GOB header (e.g. GN) and decode the missed GOB.

In low bit rate error systems (e.g. BER<10⁻⁴) then it will usually be possible to correct the error in the GBSC and so decode the rest of the segment. However, clearly it may not be possible to resolve the error in the header even when the invention is implemented, in which case the segment may be skipped in the usual fashion.

The invention will now be described with reference to the slice mode and in particular the slice structured mode as set out in Annex K of H.263 together with the Data Partitioned Slice (DPS) mode as set out in Annex V.

The structure of a slice is shown in FIG. 5. The slice header comprises a number of fields and reference will be made only to those fields that are relevant to the method according to the invention. The slice header includes a Slice Start Code SSC, which is a fixed code word 0000 0000 0000 0000 1, and a Macroblock Address MBA, which indicates the number of the first macroblock in the current slice. The macroblock data includes the following fields: Header data, HD, for all the macroblocks in the slice; Header marker HM, which is a fixed symmetrical code word 101000101 and terminates the header partition; Motion Vector Data MVD, for all the macroblocks in the slice; Last Motion Vector Value (LMVV) representing the sum of all the motion vectors for the slice; a Motion Vector Marker (MVM), a fixed code word 0000 0000 01 to terminate the motion vector partition; the DCT coefficient data; and a flag F to indicate the length of the data used to encode the segment.

A slice may comprise N×M macroblocks, where N and M are integers. In a particular example, there are eleven macroblocks per slice i.e. N=1 and M=11. Thus the first Macroblock Address of slice 0 is 1, the first Macroblock Address of slice 1 is 11, the first Macroblock Address of slice 2 is 22 etc.

As was described with reference to the GOB embodiment, the flag F is inserted by the control 105 of the encoder as the data is encoded. The flag F indicates the number of bits between one SSC and the next SSC i.e. the number of bits used to encode the slice header and the macroblock data. Alternatively, the flag F may relate to the position of the start code in the bit stream. Thus flag F provides extra information to protect the SSC so that the position of the SSC may be determined even if the SSC itself is corrupted.

On decoding, when a decoder locates a SSC, it looks for the MBA field. If the decoder finds a SSC but the following MBA is not the next expected MBA then the decoder notes that an error has been detected and looks for the length flag F preceding the current SSC. This length field indicates the number of bits that the decoder has to go back to find the first zero of the missed SSC. When the flag is found, the decoder then examines the received bit stream in the region indicated by the flag and attempts to recover the corrupted SSC for the previous slice. If this is successful the macroblock data for the slice is decoded. Alternatively, the decoder can simply skip the 17 bits of a SSC from the position indicated by the flag F and then look for the rest of the slice header (e.g. MBA) and decode the missed slice.

As in the GOB embodiment, FIG. 5 shows the flag F in the picture segment layer. However, it is envisaged that it would be more likely that the flag F would be provided in the picture layer.

The invention is not intended to be limited to the video coding protocols discussed above: these are intended to be merely exemplary. The addition of the information as discussed above allows a receiving decoder to determine the best cause of action if a picture is lost.

1. A method of decoding encoded video data, comprising:
identifying a start of an encoded segment of video data; identifying a field located in a known relation to the start of the segment
searching in the encoded data at the location indicated by the field so as to locate a start of a previous segment.

2. A method according to claim 1, further comprising:
after the step of identifying the start of the encoded segment of video data, determining that the start of a previous segment has been missed.

3. A method according to claim 2, in which the step of determining comprises comparing data at the start of the encoded segment with expected data.

4. A method according to claim 1, further comprising:
attempting identify the start of a first video segment;
when said attempt to identify the start of a first video segment is unsuccessful, examining a field located in a known relation to the start of a second video segment, and searching for the start of the first video segment at the location indicated by the field.

5. A method according to claim 1, in which the field gives the number of bits between the start of a segment and the start of the previous segment.

6. A method according to claim 1, in which the field gives the size of an encoded segment.

7. A method according to claim 1, in which an encoded segment is a Group of Blocks or a Slice.

8. Apparatus arranged to decode encoded video data using the method according to claim 1.

9. A video decoder, arranged to carry out the method according to claim 1.

10. A method of encoding video data, comprising:
encoding video data into a plurality of segments, including inserting a field into the data at a predetermined relation to the start of a segment, said field indicating the location in the encoded data of the start of a previous segment.

11. A method according to claim 10, in which the field gives the number of bits between the start of a segment and the start of the previous segment.

12. A method according to claim 10, in which the field gives the size of an encoded segment.

13. A method according to claim 10, in which an encoded segment is a Group of Blocks or a Slice.

14. Apparatus arranged to encode video data using the method of claim 10.

15. A video encoder, arranged to encoded video data using the method of claim 10.

16. A storage medium carrying computer readable code representing instructions for causing one or more processors to perform the method according to claim 1 when the instructions are executed by the processor or processors.

17. A computer data signal embodied in a carrier wave and representing instructions for causing one or more processors to perform the method according to claim 1 when the instructions are executed by the processor or processors.

18. A storage medium carrying computer readable code representing instructions for causing one or more processors to operate as the apparatus according to claim 8 when the instructions are executed by the processor or processors.

19. A computer data signal embodied in a carrier wave and representing instructions for causing one or more processors to operate as the apparatus according to claim 8 when the instructions are executed by the processor or processors.
